(19) United States
(12) Patent Application Publication
(10) Pub. No.: US 2012/0200065 A1
(43) Pub. Date: Aug. 9, 2012

(54) Electric controlled trailer hitch and link assembly alignment device

(76) Inventor: John Charles Cruz, Mooringsport, LA (US)

(21) Appl. No.: 12/927,510

(22) Filed: Feb. 8, 2011

(51) Int. Cl. B60D 1/36

(52) U.S. Cl. 280/477

(57) ABSTRACT

The electric controlled trailer hitch is a new approach to connecting to a boat, trailer, etc. with only one person. This will enable one person to back up a vehicle to a boat, trailer, etc. and with a switch activate the moveable chain. The chain can sway from right to left and the electric motor works the chain backwards and forwards in order to align with the tongue of the boat, trailer, etc. The old method of needing another person to navigate or one person having to keep backing up or moving from right to left in order to get aligned is no longer necessary.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF INVENTION

This invention relates to trailer hitch's.

### SUMMARY OF INVENTION

This invention is designed to hook a trailer to a vehicle with just one person.

My invention is a hitch assembly designed for one person to back a vehicle up and connect the hitch ball to a trailer. This invention came to me when I had to hook up my boat trailer and there was no one around to help guide me. Every time I would back my vehicle to the trailer, I would be either 6 inches or more to the left or right and would have to maneuver my vehicle to try to get close enough and still have to push the trailer tongue over the ball hitch, loaded or not and then let it down. I started looking at the square receiver hitches in different vehicle's and noticed you can pull the safety pin, lock pin and ball mount out of receiver hitch. That started the invention process. I acquired a ball mount, 12 inch receiver hitch tube, one and a half inch by eight inch chain and a electric reversible motor.

I fabricated and cut ball mount (4b) and welded chain(2) on mount sideways so that the ball mount will sway from left to right. I set chain and ball mount assembly in receiver hitch tube. A mount plate(5) was fabricated to opposite side of receiver hitch tube. Hole's were drilled for screw's and reversible extension cylinder(6), screwed on motor and hook to chain in rear of receiver tube(4a). I drilled lock pin hole(4a) one inch behind receiver tube opening and pushed lock pin in push safety so it would not come out. The fabricated trailer hitch and link assembly with an electric reversible motor can be welded to the rear of a vehicle. A three-way self centering switch harness plugged into the coupler at the rear of the device and wired to the vehicle's electric supply activates the hitch motor. When activated and lock pin is removed from the device the switch motor pushes the link assembly from four to twelve inches out of the receiver. The link assembly can be manually swayed from left to right 180 degrees to enable the trailer tongue to be attached to the link assembly even if the trailer is not perfectly aligned with the hitch. Once the electric switch(4c) is activated in the opposite direction, the electric motor will pull the hitch assembly with the trailer to the receiver hitch so that the lock pin maybe inserted into the hitch, securing the trailer to the hitch. By design, it is essential that the trailer has an adjustable tongue jack with a wheel. The jack will assist in coupling the trailer with the hitch by keeping it in the even plain as the hitch. The wheel is needed to guide the trailer when the motor is pulling the trailer to the hitch.

### DRAWINGS

FIG. 1 Side view of trailer hitch and link assemble attached to rear of vehicle.

FIG. 2 Side view of trailer hitch and link assembly with link extended.

FIG. 3 Top view of extended link showing it's ability to be moved 180 degrees from side to side.

FIG. 4a shows the receiver tube with lock pin hole.

FIG. 4b shows the chain and ball mount.

FIG. 4c shows the electric switch.

FIG. 5 Shows the reversible electric motor consisting of electrical box, mounting plate, extension cylinder and pin hole.

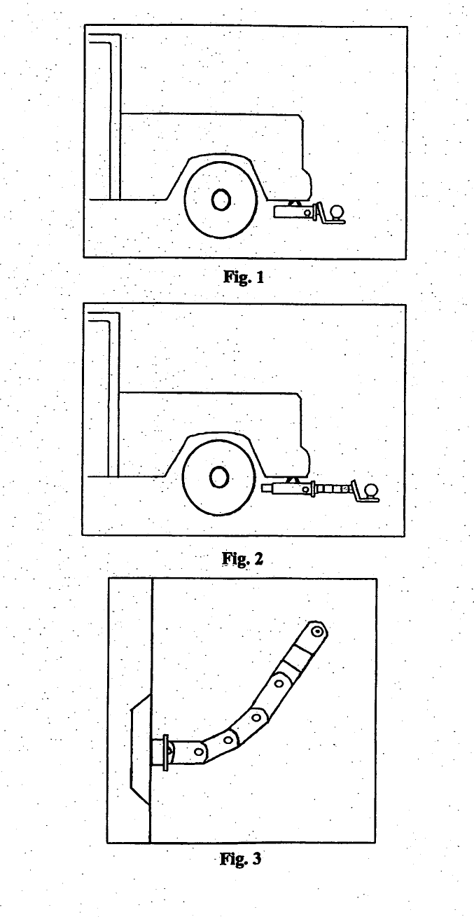

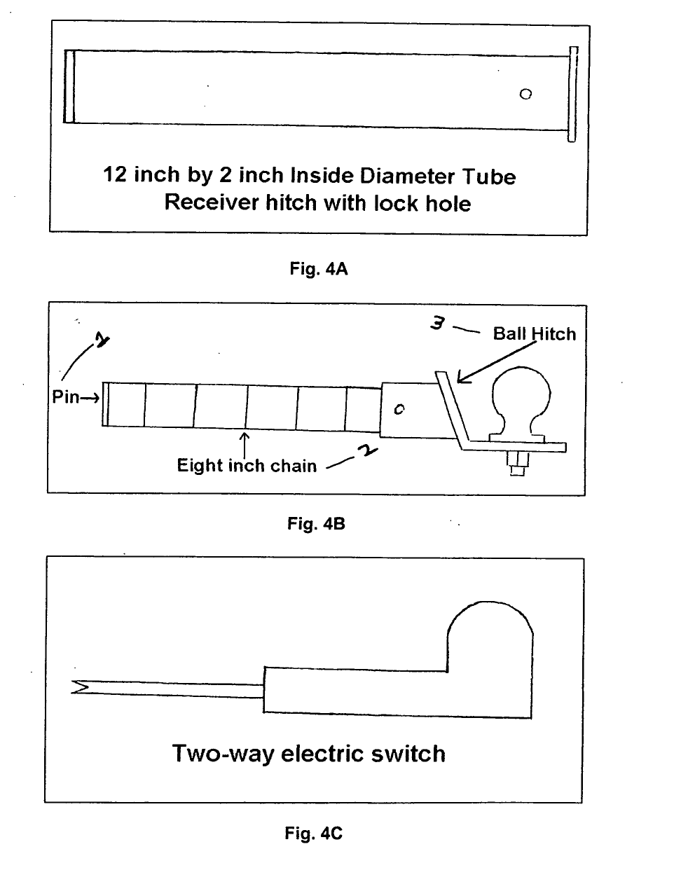

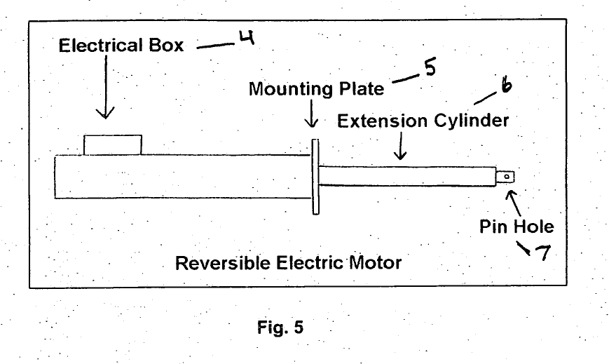

1. An electronic hitch for aligning with a boat, trailer. etc. without assistance, comprising:
(1) a chain with ball mount: and
(2) a receiver hitch tube with reversible motor cylinder:
(3) said chain with ball mount connected to said hitch tube and motor cylinder:
(4) whereby able to sway chain left to right with electric switch to provide ease of access for the user to activate the motor when it is time to tow a vehicle
